(19) United States
(12) Patent Application Publication
(10) Pub. No.: US 2018/0288975 A1
(43) Pub. Date: Oct. 11, 2018

(54) POULTRY HOUSING APPARATUS AND METHOD FOR EGG LAYING DUCKS

(71) Applicant: Big Dutchman International GmbH, Vechta (DE)

(72) Inventor: Volker Auffarth, Vechta (DE)

(73) Assignee: Big Dutchman International GmbH, Vechta (DE)

(21) Appl. No.: 15/947,961

(22) Filed: Apr. 9, 2018

(30) Foreign Application Priority Data
Apr. 10, 2017 (DE) 202017102141.6

(51) Int. Cl. A01K 31/16; A01K 31/22; A01K 31/17

(52) U.S. Cl. CPC A01K 31/165; A01K 31/17; A01K 31/22

(57) ABSTRACT

The invention relates to a poultry housing unit, in particular for ducks to lay eggs, a poultry house, in particular for keeping ducks, and a method for keeping ducks. The invention relates to a poultry housing unit for ducks to lay eggs, comprising a plurality of nests arranged one beside the other and above a floor area, at least one supporting element extending in the vertical direction from a lower supporting end to an upper free end and arranged relatively movably in the vertical direction in relation to the floor area, and a locking element which interacts with the supporting element to block movement of the supporting element in a vertically upward supporting direction relative to the floor area and to allow movement of the supporting element relative to the floor area in a vertically downward direction of free motion.

### CROSS-REFERENCE TO FOREIGN PRIORITY APPLICATION

The present application claims the benefit under 35 U.S.C. § 119(b) of German Application No. DE 20 2017 102 141.6 filed Apr. 10, 2017, titled “Poultry housing unit, in particular for ducks to lay eggs, and method therefor.”

### FIELD OF THE INVENTION

The invention relates to a poultry housing unit, in particular for egg laying by poultry, such as ducks or hens, a poultry house, in particular for keeping poultry, such as ducks or hens, and a method for keeping poultry such as ducks or hens.”

### BACKGROUND OF THE INVENTION

Egg-laying facilities for ducks are basically known from the prior art. In known devices for ducks, nest boxes in which a duck can lay an egg are generally provided. The egg can then be transported out of the nest box either manually, semi-automatically, or automatically. One disadvantage of egg laying facilities known from the prior art is that the eggs cannot be taken out of the nest box, or only to a limited extent, or that they cannot be automatically transported out of the nest box, or only to a limited extent. More particularly, there are various factors which prevent eggs from being transported away or which impair such transport.

Another disadvantage of known devices is that the nests do not provide the kind of lighting that is desired, thus restricting the well-being of the animals and reducing their egg laying productivity. A particular disadvantage of the devices known from the prior art, furthermore, is that the poultry housing units generally accumulate dirt. One reason this happens is that new litter is put into the pen, and as the amount of litter increases, some of it ends up in the poultry housing unit. Regular cleaning of the poultry housing unit is therefore necessary. This must normally be done manually and consumes personnel resources.

Due to the litter in the pen, conditions where the ducks enter the nest are continually changing, which means the ducks must constantly adapt to new conditions, which, in turn, can lead to deterioration of the animals' well-being. Ducks, in particular, are slow to adapt to such changed conditions. Furthermore, duck pens get dirty again very quickly after being cleaned. Yet another disadvantage of the housing units known from the prior art is that the ducks can stay in the nest box at night and soil it. As a result, keeping ducks is becoming expensive, and challenging as well, especially given the increasingly tough requirements regarding the well-being of the animals. In addition to the fundamental requirements to be met with regard to the well-being of the animals, this low level of well-being results in the animals having lower levels of productivity in egg production.

Besides the general requirements to be met when keeping ducks, for example, with regard to cleanliness of their housing area, the well-being of the animals, as well as keeping costs low and productivity high, it is therefore an object of the present invention to provide a poultry housing unit for ducks to lay eggs, a pen for keeping ducks, and a method for keeping ducks which enables nest conditions to be kept stable.

### SUMMARY OF THE INVENTION

According to a first aspect of the present invention, the object specified at the outset is achieved by a poultry housing unit, in particular for ducks to lay eggs, comprising a plurality of nests arranged one beside the other and above a floor area, at least one supporting element extending in the vertical direction from a lower supporting end to an upper free end and arranged relatively movably in the vertical direction in relation to the floor area, and further comprising a locking element which interacts with the supporting element to block movement of the supporting element in a vertically upward supporting direction relative to the floor area and to allow movement of the supporting element relative to the floor area in a vertically downward direction of free motion.

The invention is based, inter alia, on the realisation that the productivity of duck egg production is affected more strongly by the well-being of the animals than is the case with other egg-laying animal species. It was also realised that the well-being of ducks is positively affected when they experience stable nest conditions. Due to the regular addition of litter, however, the height of the litter in the pen generally increases, which generally results in changes in the conditions where the ducks enter the nest. Continual removal of the old litter before spreading new litter is not an option for commercial reasons alone, because the personnel resources needed would be too great. That option is generally ruled out for behavioural reasons also, because the animals' well-being is disrupted by the routine presence of humans.

The poultry housing unit according to the invention can be adapted with minimal manual effort or even automatically to different litter heights in the pen, by the at least one supporting element extending, for example by its own weight, when the poultry housing unit is raised. The heights of the floor area and of the poultry housing unit above a supporting area, on which the supporting elements stand with their supporting end, are thus changed, with the result that the distance between the floor area to a mounting pile of litter on the supporting area is kept constant. The dirtiness of the poultry housing unit can be kept under control as a consequence, and the well-being of the animals can be further enhanced.

In operating mode, it is preferable that the floor area is substantially horizontal. The floor area can be formed as a continuous surface or by two or more individual floor segments. The floor area preferably extends in the axial direction and in the width direction from respective opposite ends of the poultry housing unit.

In one preferred development, the poultry housing unit has a frame. The frame preferably has two parallel frame elements in the longitudinal direction of the poultry housing unit and two parallel frame elements in the width direction. The floor area can be attached to the frame, for example. The frame may have transverse and/or longitudinal bars which improve the stability of the poultry housing unit and on which the nest boxes can be arranged. The frame elements of the frame are preferably of steel, and/or aluminium, and/or plastic.

The individual nest boxes preferably comprise a first side wall and a second side wall. The first side wall and the second side wall are preferably arranged with their wall areas parallel to each other. The first side wall and the second side wall are also arranged preferably perpendicular to the floor area. The first and the second side wall extend preferably parallel to the width direction of the poultry housing unit. It is particularly preferred that the nest boxes are each bounded laterally by side walls and that the side wall between a first nest box and a second nest box is formed by a partition wall. It is also preferred that the nest boxes are arranged one beside the other along the longitudinal direction of the poultry housing unit. It is also preferred that the poultry housing unit has a roof element which covers the nest boxes partly or substantially completely.

The nest boxes arranged one beside the other in the longitudinal direction thus form a row of nest boxes. It may also be preferred that the poultry housing unit has a first row of nest boxes and a second row of nest boxes. It is particularly preferred that the first row of nest boxes and the second row of nest boxes are spaced apart in the width direction, and/or that an egg conveyor is arranged between the first row of nest boxes and the second row of nest boxes. It may also be preferred that the first row of nest boxes has the same quantity of nest box as the second row of nest boxes, and/or that the first row of nest boxes and the second row of nest boxes have the same dimension in the longitudinal direction. It may also be preferred that there is substantially no spacing between the first row of nest boxes and the second row of nest boxes. It may also be preferred that the floor area has one or more through holes, so that eggs that have been laid can pass through from the floor area into an area underneath the nest boxes and be conveyed away from there. An egg conveyor provided for this purpose underneath or flush with the floor area may be driven manually or by a motor means, for example, by means of an electrical drive.

The at least one supporting element preferably has its an own weight such that the supporting element, when there is no load on it from the poultry housing unit, i.e. when there is no load on the supporting end, moves out by its own weight, and in particular that it also moves out by its own weight against a mechanical resistance of the blocking mechanism. It is also preferred that the lower supporting end of the supporting element is secured to the supporting area.

The at least one supporting element extends in the vertical direction from the lower supporting end to the upper free end. The direction of extension of the supporting element in the vertical direction is also understood to mean that one component of the direction of extension runs in the vertical direction. This means the supporting element may also be inclined in such a way that the direction of extension between the lower supporting end and the upper free end has a vertical component and a horizontal component.

The supporting element preferably has a cross section which is substantially triangular, rectangular, or polygonal. The cross section can also be round or elliptical, or have a round circumferential section. It is also preferred that the cross section has an elongated rectangular shape, so that the supporting element is plate-shaped. The supporting element is preferably arranged on the poultry housing unit in such a way that its direction of extension, or one component of its direction of extension, is oriented substantially parallel to a surface normal of the floor area.

It is also preferred that the poultry housing unit has two or more supporting elements. The at least one supporting element is also arranged movably. For example, the poultry housing unit may have a guide device in which the supporting element is guided along its direction of extension. It is particularly preferred that the guide mechanism is tubular in shape.

Due to the movable arrangement of the at least one supporting element, the latter has at least one direction of movement. In operating mode, at least one directional component of said movement is vertical. That means, in particular, that the supporting element can be moved from the poultry housing unit in the direction of the supporting area. As a consequence, the lower supporting end of the supporting element can be moved away from the floor area, so the distance between the lower supporting end and the nest box and/or the floor area can be changed, and, more particularly, can be increased. The distance between the nest boxes arranged above the floor area and the supporting area can be increased as a consequence. The direction of movement is preferably parallel to a surface normal of the floor area.

In operating mode, the lower supporting end of the supporting element faces the supporting area, such as a poultry house floor, on which the poultry housing unit is placed. The upper free end faces away from the lower supporting end of the supporting area.

The at least one supporting element is arranged and adapted in such a way in its direction of extension that it is made substantially immobile in the supporting direction from the lower supporting end to the upper free end by a preferably releasable locking mechanism. This means that, as soon as a force is applied to the lower supporting end in the direction of the upper free end, the supporting element remains substantially unmoved by said force. The supporting element is latched, for example, in such a way that it cannot be moved in the supporting direction.

The supporting element is also arranged and adapted in such a way that it is movable in the direction of free motion. If a force is exerted on the supporting element from the upper free end in the direction of the lower supporting end, the supporting element is moved in its direction of extension. The supporting element can thus be moved out by exerting a force in the direction of free motion. The supporting element is preferably arranged and adapted in its direction of extension in such a way that the weight force of the supporting element is sufficient to allow a movement in the direction of free motion as soon as there is no force acting in the supporting direction, or a force acting in the direction of free motion, for example, by its own weight, is greater than a force acting in the supporting direction, for example, a frictional force. A supporting element of the kind described in the foregoing can be realised, for example, by providing an override or range of motion, in particular, a linear override. The supporting element preferably consists of or contains steel. It is also preferable that the supporting element consists of or contains aluminium or plastic.

The override blocks retraction of the supporting element in the supporting direction and allows extension of the supporting element in the direction of free motion. By this means, it is possible for the height of the floor area and the nest boxes above a supporting area on which the poultry housing unit is placed to be adjusted to a growing pile of litter below and/or beside the poultry housing unit. The blocking effect of the override, namely to prevent retraction, can preferably be released so as to be able to lower the poultry housing unit again after removing the pile of litter that has collected. However, the blocking effect can also be unreleasable, in which case the supporting elements are designed in such a way that they can be pulled downwards out of their guide mechanism and can then be inserted back into their guide mechanism from above, in order to obtain a fully retracted state after a fully extended state.

The poultry housing unit is preferably characterised by a side rail extending along one side in the region of the floor area and having one or more recesses in the region of the nest boxes. Side rails are provided in poultry housing units for gamefowl, in particular, where a game bird has to climb onto the side rail first and then step down into the nest box in order to enter the poultry housing unit. A poultry housing unit characterised by a recessed side rail has the particular advantage that it makes it simpler for ducks to enter their nest. This is due, in particular, to the anatomical shape and structure of the duck's feet, because these are particularly wide.

By means of the poultry housing unit according to the invention, it is possible to provide constant conditions where the ducks enter the nest, even when litter is continually added to a pen. For example, the poultry housing unit can be placed on a nest lifting device, which raises the poultry housing unit in the vertical direction. This raising allows the supporting elements to be extended, and it is possible, for example, for the supporting element to extend automatically if the supporting element is suitably arranged and has an appropriate weight. This is made possible by arranging the supporting element so that it can move in the direction of free motion. After the poultry housing unit has been brought into the desired position or height above the supporting area, the nest lifting device can be de-energised again, for example, and the poultry housing unit rests on the at least one supporting element, because the latter is arranged substantially immovably in the supporting direction. The height of the poultry housing unit above the supporting area can thus be adjusted and a stable position achieved within a very short time. Furthermore, it is possible for a plurality of poultry housing units to be adjusted in height within a very short time. In one preferred variant of the invention, as will be described in more detail below, it is also possible to lower the poultry housing unit by means of a release member.

It is also advantageous that there is no need for an operator to enter the pen in order to adjust the height. Not only does this save personnel expenses and personnel resources, but it also results in an improvement in the well-being of the animals. When an operator enters the pen, the animals, and especially ducks, are disturbed, which can result in stress. Furthermore, the poultry housing units need to be cleaned less often, which also reduces personnel expenses and personnel resources and further enhances the well-being of the animals.

The hoistable poultry housing unit has the further advantage that the one or more poultry housing units can be pulled up so far and with little effort that the supporting elements are extended by the maximum amount, or are lifted off the supporting area, and that this raised position of the poultry housing units allows the pen to be cleaned without much effort.

In one preferred variant of the poultry housing unit, the floor area is formed by a grid arrangement and/or rib arrangement and/or frame arrangement and has a triangular, rectangular or polygonal geometry, wherein a first supporting element is preferably arranged in an area adjacent to a first corner, and/or a second supporting element is arranged in an area adjacent to a second corner, and/or a third supporting element is arranged in an area adjacent to a third corner and/or a fourth supporting element is arranged in an area adjacent to a fourth corner.

All or some of the supporting elements can also be arranged preferably directly at the corners. Furthermore, the supporting elements can also be arranged in the area of edges. It is particularly preferred that the supporting elements are arranged at edges which extend between the first and/or second and/or third and/or fourth corner. There is also the possibility of arranging the supporting elements under the floor area. It is also preferred that the at least one supporting element can be moved parallel to a surface normal of the floor area. The direction of extension of the at least one supporting element is also preferably parallel to a surface normal of the floor area of the frame.

According to another preferred variant of the poultry housing unit, the at least one supporting element is held by means of a blocking mechanism against movement along its direction of extension, wherein the blocking mechanism preferably comprises at least one spring-mounted catch, in particular, a linear range of motion, and/or at least one movable latching element, and/or at least one frictional resistance, and/or at least one hydraulic unit, and/or a brake mechanism, preferably comprising brake shoes.

When there is at least one spring-mounted catch, the supporting element preferably has recesses designed to match the catch. The catch and the recesses are preferably designed in such a way that the immobility in the supporting direction and the mobility in the direction of free motion of the supporting element is ensured. It is preferred, also in the case where there is at least one movable latching element, that the supporting element has matching recesses so that the supporting element is substantially immobile in the supporting direction and mobile in the direction of free motion. As an alternative to the aforementioned recesses, it is also possible for thickened sections, bulges or arrangeable elements to be arranged on the supporting element. Alternatively, a frictional resistance can also be provided in order to allow immobility of the supporting element in the supporting direction and mobility of the supporting element in the direction of free motion. For example, the blocking mechanism can form a pair of friction surfaces with the supporting element, with an anisotropic coefficient of friction in the direction of motion of the supporting element. For example, in this way, it is possible for a frictional resistance between the blocking mechanism and the supporting element to be high in the supporting direction and low in the direction of free motion. It is possible as a result to provide mobility in the direction of free motion and immobility in the supporting direction. The brake shoes allow the supporting element to be clamped in position, preferably due to an angular means of positive guidance, with the clamping being in the supporting direction only, and not in the direction of free motion. When the hydraulic unit is used, it is particularly preferred that the adjustment of the supporting element is infinitely variable. In the variants of the blocking mechanism described in the foregoing, it is particularly preferred that these include a release mechanism by means of which it is possible for the supporting element to move in the supporting direction.

This variant of the poultry housing unit has the special advantage that the supporting element can be arranged so that it can move safely in the direction of free motion and is substantially immobile in the supporting direction. It is possible in this way to ensure that the poultry housing unit is realised safely and robustly. Production costs can also be kept low.

Another preferred development of the poultry housing unit is characterised in that it has a guide mechanism for the at least one supporting element, wherein the guide mechanism has a specifically tubular geometry with an inner cross section, wherein the at least one supporting element has an outer cross section, wherein the inner cross section of the guide mechanism and the outer cross section of the supporting element have the same geometry, and the inner cross section of the guide mechanism and the outer cross section of the supporting element are specifically designed such that the at least one supporting element can be movably arranged inside the guide mechanism. Guiding the supporting element in such a way by means of a guide mechanism allows the poultry housing unit to be moved safely. In particular, such a guide mechanism makes it possible for the poultry housing unit to be raised by means of a labile nest lifting device, while nevertheless ensuring stability afterwards, because the load can be taken off the nest lifting device, which does not have to absorb any permanent forces, which are absorbed instead by the at least one guided supporting element. It is thus possible to raise the poultry housing unit in a simple and cost-efficient manner. A guide mechanism is preferably provided for each supporting element.

It is also preferred that the at least one supporting element has recesses on at least one outer side, the at least one spring-mounted catch has a latching end at a distance from a pivot point, wherein said latching end can be arranged in the recesses, and a force in the direction of said recesses is preferably exerted upon it by a spring, and the recesses and the catch are arranged and adapted such that the at least one supporting element is substantially unable to move in the supporting direction, wherein the latching end latches into a recess when the at least one supporting element moves in the supporting direction, and the at least one supporting element can be moved in the direction of free motion, wherein the latching end does not latch into a recess when the at least one supporting element moves in the direction of free motion.

A combination of a catch with matching recesses provides the advantage of a simple and robust blocking mechanism which is simple to maintain and which also provides a low likelihood of failure. The production costs of such a poultry housing unit are also low. It is particularly preferred that the spring has such a spring force that the supporting element, when there is no load on it from the poultry housing unit, and by its own weight in the direction of free motion, can move the catch out of a latched position and can then extend in the direction of free motion.

In another preferred development of the poultry housing unit, the latter comprises a release member that is arranged and adapted to allow movement of the at least one supporting element in the supporting direction. It is particularly preferred in this regard that the release member engages the spring-mounted catch and is arranged and adapted to space the latching end from the supporting element.

According to another preferred variant of the invention of the poultry housing unit, the lower supporting end of the at least one supporting element is placed in a standing mode on a supporting area, the weight of the poultry housing unit is at least partially on the at least one supporting element, and the at least one supporting element supports the poultry housing unit at a defined distance above the supporting area, and in an adjustment mode the weight of the poultry housing unit is substantially not on the at least one supporting element, and the at least one supporting element is arranged substantially movably by its own weight in the direction of free motion. In the adjustment mode, the weight of the poultry housing unit can be held by a holding device, which is realised, for example, by means of a rope on the poultry housing unit. This takes the load off the one or more supporting elements, and when the poultry housing unit is raised, the supporting element is extended, for example by its own weight, with the result that the lower supporting end mainly rests on a supporting area or returns to the supporting area due to its own weight. As soon as the weight force of the poultry housing unit is exerted on the supporting element, the poultry housing unit is supported above the supporting area solely by the supporting element(s), at a distance defined by the extended state of the supporting element(s).

In another preferred variant of the poultry housing unit, the latter comprises a release member that is arranged and adapted to allow movement of the at least one supporting element in the supporting direction. The release member allows movement of the at least one supporting element in the supporting direction, thus allowing the distance of poultry housing unit from a supporting area to be reduced. For example, after a pen has been emptied of litter, the poultry housing units can be lowered again singly, or also jointly in the case of an arrangement consisting of a plurality of poultry housing units. The release member may interact in this connection with a blocking mechanism of the kind described in the foregoing and cancel the blocking effect by removing a braking or latching effect. When at least one spring-mounted catch or some other blocking mechanism acting on the supporting element with an advancing movement, the release member may be provided in the form of a cable pull system, for example. The release member may be designed to prevent the catch from latching into the recess, or to release a latched catch from its latched-in position. The release member can be operated by a hand winch or can be driven by a motor. It is possible, in particular, for a plurality of blocking mechanisms, for example a plurality of catches, to be released by a single, central hand winch or by a single central motor. It is particularly preferred that the blocking mechanism includes at least one spring-mounted catch, and that the release member is arranged and adapted to cause the catch to disengage from the recess, wherein said disengagement can be triggered preferably centrally, for example via a pulling mechanism.

According to another preferred variant of the poultry housing unit, the latter has a bridging element that is arranged and adapted to allow poultry, in particular ducks, access to the floor area, wherein the bridging element preferably has a flat and/or stepped surface and also preferably extends slopingly downwards from one edge of the poultry housing unit. The bridging element preferably extends parallel to the longitudinal direction of the poultry housing unit. The bridging element is preferably designed as a perforated metal plate. It is also preferred that the bridging element consists of or includes plastic and/or has a mesh-like and/or perforated surface. It is further preferred that the webs of the mesh-like surface are rounded so that the animals, in particular the ducks, cannot cut themselves on them. It is also preferred that the bridging element can be detached and/or has an attachment device. In particular, the bridging element can be attached pivotably about a horizontal axis to the poultry housing unit so as to follow any raising and lowering movement of the poultry housing unit, without any end of the bridging element lying on the supporting area being lifted off the supporting area.

Another preferred development of the poultry housing unit is characterised in that it comprises a covering element, wherein in operating mode, at least sections of said covering element are arranged over the floor area in the vertical direction and that a clear height between the covering element and the floor area can be changed by the covering element being movably arranged, and the clear height can be changed in a nest entrance area, in particular. The covering element preferably comprises movable and immovable sections. It is particularly preferred that movable covering elements are arranged over the nest entrance areas.

It is further preferred that an egg collecting unit is arranged on one side of the at least one nest box, wherein laying sections of the nest boxes are spaced apart in the vertical direction from the egg collecting unit, wherein an adjustable gradient is provided from the laying section to the egg collecting unit. It is particularly preferred that the nest boxes are each provided, in sections at least, as an element which can be tilted about at least one horizontal axis. It is particularly preferred that the laying section is arranged on or at the tiltable element, or forms the tiltable element. When a tiltable element is provided as the laying section, the laying section can be arranged at an angle to a horizontal area. Such a gradient causes an egg that has been laid to roll out of the nest box under the force of gravity and to roll in the direction of the egg collecting unit. It is particularly preferred that this gradient comprises an angle of less than 7°, 8°, 9°, or 10° and greater than 5°, 6°, 7°, or 8°. The special advantage of such an adjustable and tiltable element is that the poultry housing unit can be adapted to the individual needs of the animals. It is thus possible, in particular, to adapt it to the size of the animals and/or of the eggs that are laid.

In another preferred development of the poultry housing unit, the latter has a nest access barrier that is arranged and adapted to block access for the poultry to at least one of the nest boxes. The nest access barrier is preferably coupled mechanically to an actuating device that allows the nest access barrier to be actuated from a location remote from the poultry housing unit. It is particularly preferred that the poultry housing unit has a barrier pull element that is arranged and adapted to move the nest access barrier. It is particularly preferred that the barrier pull element is a rope and/or a wire that is guided through the roof.

According to another aspect of the invention, the object specified at the outset is achieved by a poultry house, in particular for the production of duck eggs, comprising a poultry housing unit according to at least one of the variants described in the foregoing, wherein the poultry housing unit is arranged at a nest lifting device that is arranged and adapted to move the poultry housing unit in such a way relative to a supporting area that a distance from said supporting area is increased. The well-being of the animals is particularly enhanced by such a poultry house, and personnel expenses and personnel resources are reduced.

According to yet another aspect of the present invention, the object specified at the outset is achieved by a method for producing duck eggs, comprising the steps of providing a poultry housing unit according to at least one of the variants described in the foregoing and/or a poultry house according to at least one of the variants described in the foregoing, moving the poultry housing unit in an adjustment mode in a substantially vertical direction, wherein a distance between a supporting area and the floor area is increased, wherein the at least one supporting element extends by its own weight in the adjustment mode and supports the poultry housing unit in a subsequent standing mode with a defined distance between the supporting area and the floor area.

The method according to the invention and the possible developments thereof have features or steps that make them specifically suitable for use with a poultry housing unit according to the invention and with the various developments thereof. For further advantages, variants of the invention and details of these other aspects and possible developments thereof, reference is made to the above description of the respective features and developments of the poultry housing unit.

### BRIEF DESCRIPTION OF THE DRAWINGS

Preferred embodiments of the invention shall now be described by way of example and with reference to the attached Figures, in which:

FIG. 1 is a schematic, three-dimensional view of an embodiment of a poultry housing unit;

FIG. 2 is a schematic, two-dimensional front view of the poultry housing unit shown in FIG. 1;

FIG. 3 is another schematic, two-dimensional side view of the poultry housing unit shown in FIG. 1;

FIG. 4 is a schematic, three-dimensional view of a blocking mechanism of the poultry housing unit shown in FIG. 1;

FIG. 5 is a schematic, three-dimensional view of an embodiment of an adjusting device for a nest access barrier in the poultry housing unit shown in FIG. 1;

FIG. 6 is another schematic, three-dimensional view of the adjusting device for the nest access barrier in the poultry housing unit shown in FIG. 1;

FIG. 7 is a schematic, three-dimensional view of an embodiment of a tiltable nest element of the poultry housing unit shown in FIG. 1;

FIG. 8 is a schematic, three-dimensional detail view of an embodiment of a poultry housing unit;

FIG. 9 is another schematic, two-dimensional front view of the poultry housing unit shown in FIG. 1;

FIG. 10 is a schematic, two-dimensional detail view of an edge protector;

FIG. 11 is a schematic, three-dimensional view of the poultry housing unit shown in FIG. 1, with the supporting elements shown in the extended state; and

FIG. 12 is a schematic, three-dimensional detail view of a release mechanism.

### DETAILED DESCRIPTION OF THE PREFERRED EMBODIMENTS

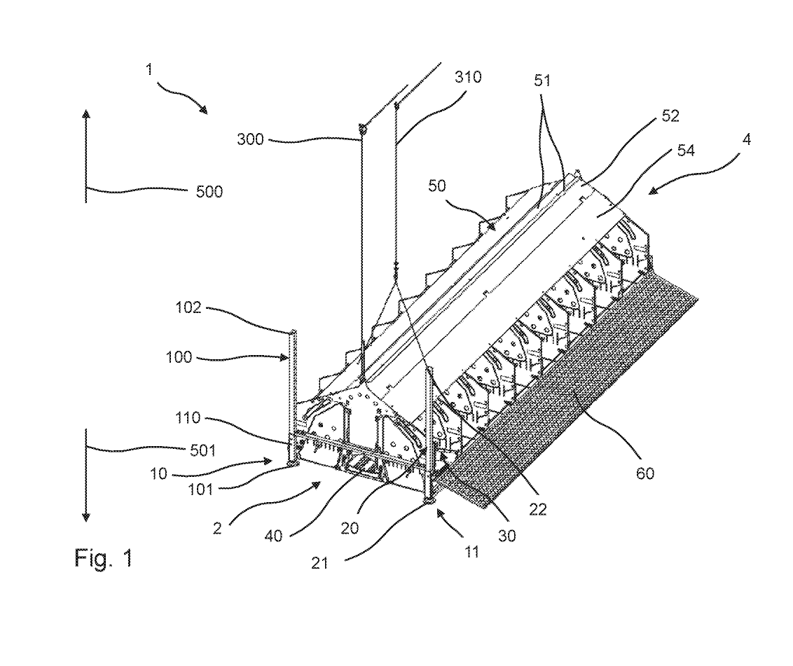

As referenced in the Figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in FIG. 1. However, it is to be understood that the present disclosure may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

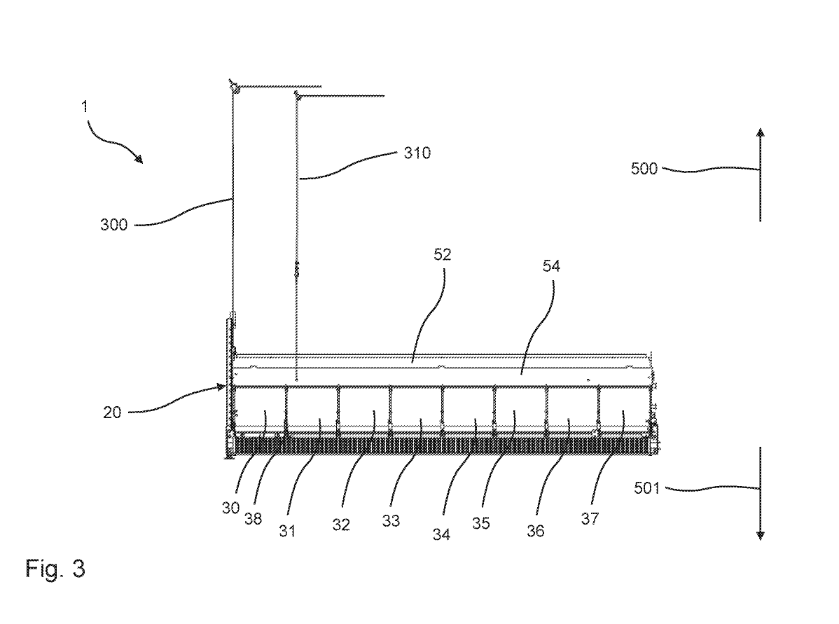

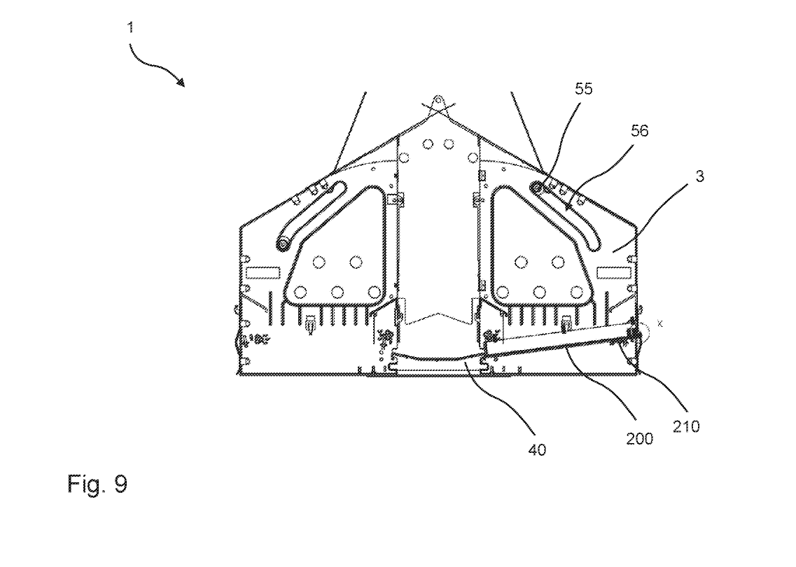

Identical elements, or elements with substantially the same or similar function are marked with the same reference signs. An exemplary embodiment of a poultry housing unit according to the invention is shown in FIGS. 1-12. Poultry housing unit 1 extends in the longitudinal direction from a first end 2 to a second end 4. Nest boxes 30, 31, 32, 33, 34, 35, 36, 37 are arranged one beside the other in the longitudinal direction. Two neighbouring nest boxesi.e., 30, 31 are separated one from the other by a partition wall 38. In the region of its first end 2, poultry housing unit 1 has a first corner 10 and a second corner 11. A first supporting element 100 is arranged at the first corner 10. The first supporting element 100 extends in a vertical direction, perpendicular to the longitudinal direction of the poultry housing unit 1, from a first lower supporting end 101 to a first upper free end 102.

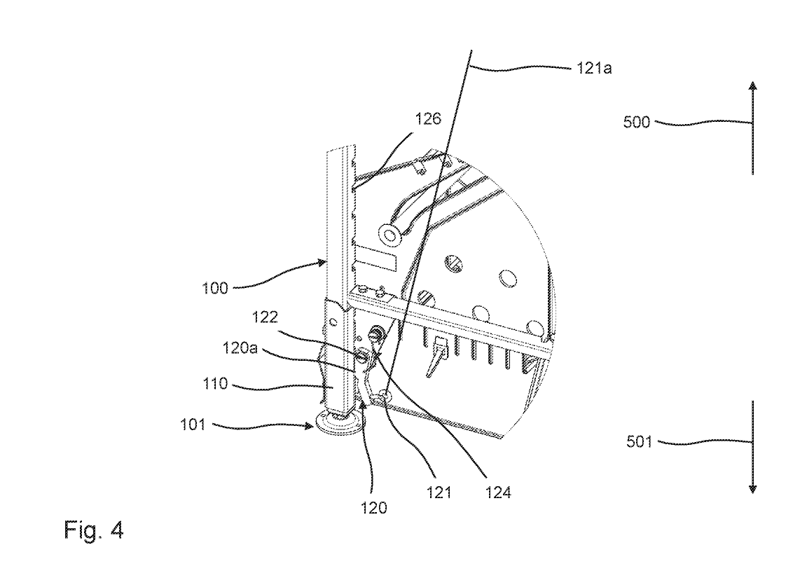

As is shown in FIG. 4, in particular, the first supporting element 100 has a substantially rectangular cross section. A first guide mechanism 110 is arranged at the first corner 10. The first guide mechanism 110 forms a rectangular through hole in which the first supporting element 100 is arranged and is guided for vertical displacement relative to the guide mechanism. The first supporting element 100 has an outer peripheral area which matches an inner peripheral area of the through hole of the first guide mechanism 110.

The first supporting element 100 has a plurality of recesses 126. The recesses are arranged one beside the other in a vertical row. Poultry housing unit 1 has a first locking element in the form of a first catch 120, catch 120 being arranged and adapted in such a way that it can latch with a nose 120a into one of recesses 126. Catch 120 and recesses 126 are designed in such a way that movement of supporting element 100 in an upward vertical supporting direction 500 is blocked by the nose 120a of the catch 120 latching into a recess 126, whereas movement in an opposite, downward vertical direction of free motion 501 is allowed. For this purpose, catch 120 is arranged about a first pivot point 122, which is above the nose 120a of the catch 120 and positioned laterally adjacent to the supporting element 100. A spring element 124 is arranged and design in such a way that it exerts a spring force on catch 120, such that a force that presses nose 120a of the catch 120 towards the first supporting element 100 is always applied to the catch 120. As a result, catch 120 can pivot about its rotational axis against the force of spring 124 when the supporting element 100 is moved downwards by its own weight, thus exerting a force on the nose 120a of the catch 120 via the recesses. In contrast to that, catch 120 is held self-reinforcingly in the recess 126 when a upwardly directed force acts on the supporting element 100. Supporting element 100 can therefore be extended downwards, but it is blocked by catch 120 from retracting upwards. The weight of the first supporting element 100, the friction of the first supporting element 100 inside the first guide mechanism 110 and the spring force of spring 124 with which catch 120 is pressed into recesses 126, are coordinated with each other to such an extent that, on the one hand, spring 124 presses catch 120 with sufficient force into recesses 126, thus fulfilling its latching function, and, on the other hand, movement of the first supporting element 100 in the direction of free motion 501 is made possible as soon as there is no load on supporting element 100, in that the catch is pressed out of the recess 126. In particular, the catch 120 can latch by positive engagement in the recess 126 under the effect of the weight force of the poultry housing unit on the supporting element 100, thus preventing the catch 120 from moving undesirably out of the recess 126.

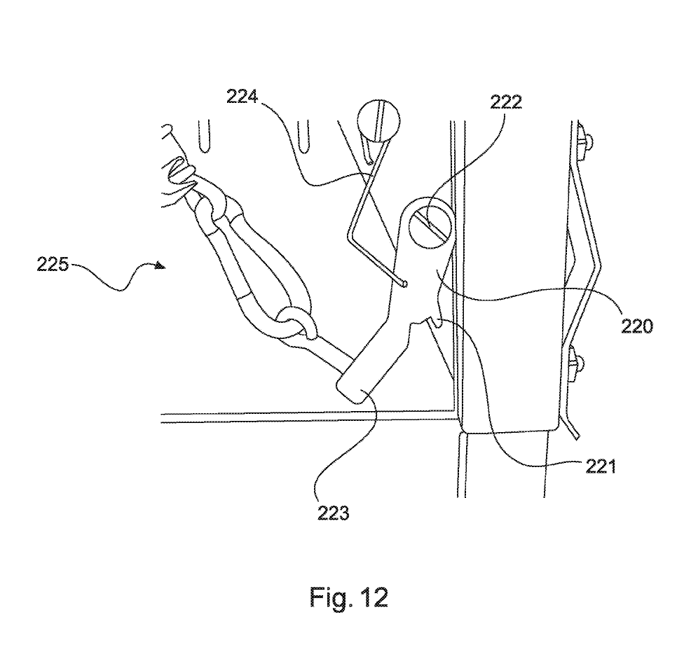

The poultry housing unit 1 also has a release member 121a which engages an eyelet 121 attached to catch 120 to move catch 120 against the force of the spring. As a result, catch 120 is not arranged in one of recesses 126 and is not latched in. When release member 121a is actuated, poultry housing unit 1 can be moved in the direction of free motion 501 and can thus be lowered. The unlatching of catch 120 from one of recesses 126 can be supported by means of a stand relieving element, because it is easier for the catch 120 to unlatch from one of recesses 126 when there is no load on supporting element 100. The stand relieving element can be provided in the form of rope or as a Bowden cable, for example. Another possible release mechanism 225 is shown by way of example in FIG. 12.

At the second corner 11, there is arranged a second supporting element 20 that extends from a second lower supporting end 21 to a second upper free end 22 and is arranged analogously with the first guide element 100 in a second guide mechanism 23. A stand element 24 is provided at its lower supporting end 101 and it is made mobile or immobile by means of a second locking element in the form of a second catch 26.

Poultry housing unit 1 also has a roof 50 with a roof ridge, from which roof elements extend slopingly downwards. Two roof rockers 51 for preventing or at least making it difficult for poultry, in particular ducks, from sitting on the roof, are movably arranged on the roof ridge. A removable covering element 52 adjoins each side of the roof ridge. A fixed covering element 54 is arranged on the side of the removable covering element 52 facing away from the roof ridge. In operating mode, fixed covering element 54 is securely arranged and in particular is not designed to be removed in the operating mode.

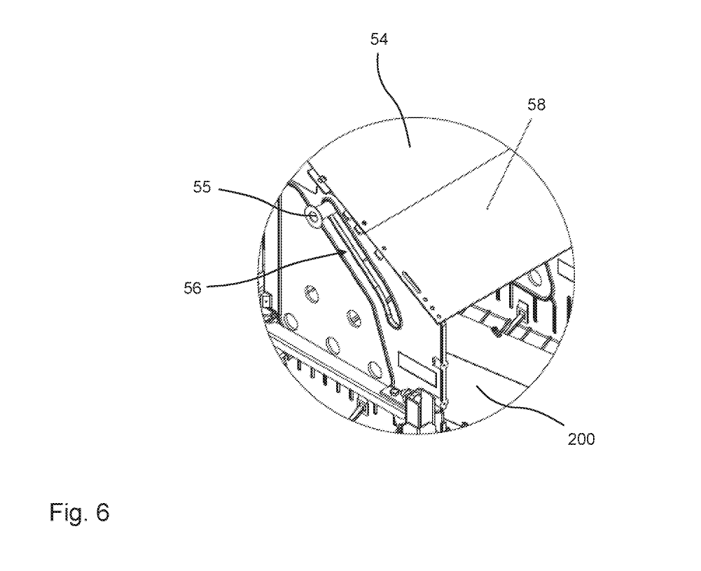

In FIG. 6, a nest roof extension element 58 is shown which is provided in addition to the removable covering element 52 and the fixed covering element 54 and which forms part of the roof 50 of poultry housing unit 1. The nest roof extension element 58 can be variably mounted in relation to a clear height above the floor area, so it can likewise be used to adjust the brightness in the nest box or to cast a shadow into the nest.

It is particularly preferred that the nest roof extension element 58 is arranged pivotably about a horizontal pivot axis. It is further preferred that the horizontal pivot axis is oriented substantially parallel to the longitudinal direction of poultry housing unit 1. It is also preferable that the pivot axis is arranged adjacent to an inwardly facing edge of the fixed covering element 54, which extends in the longitudinal direction of poultry housing unit 1.

Alternatively or additionally thereto, the nest roof extension element 58 may also be movable. For example, the nest roof extension element 58 may be arranged and adapted so as to be moved under and/or over the fixed covering element 54 and/or the removable covering element 52.

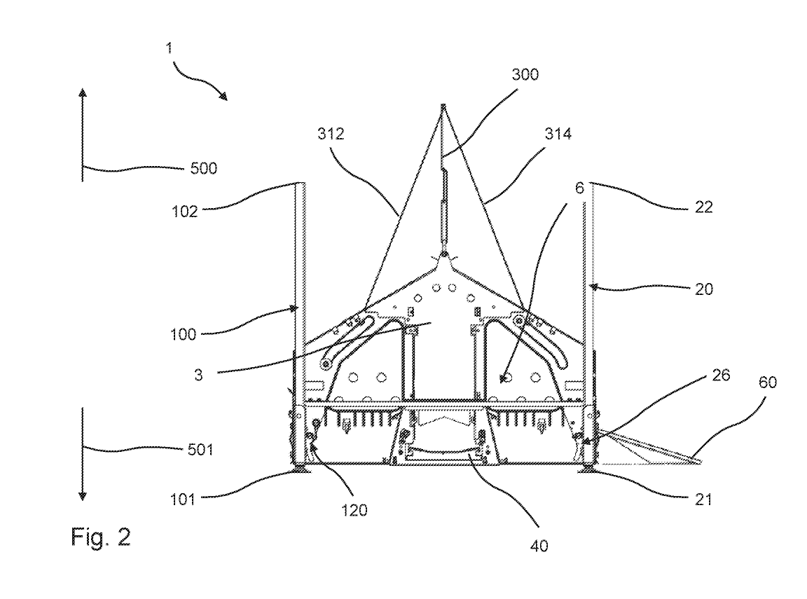

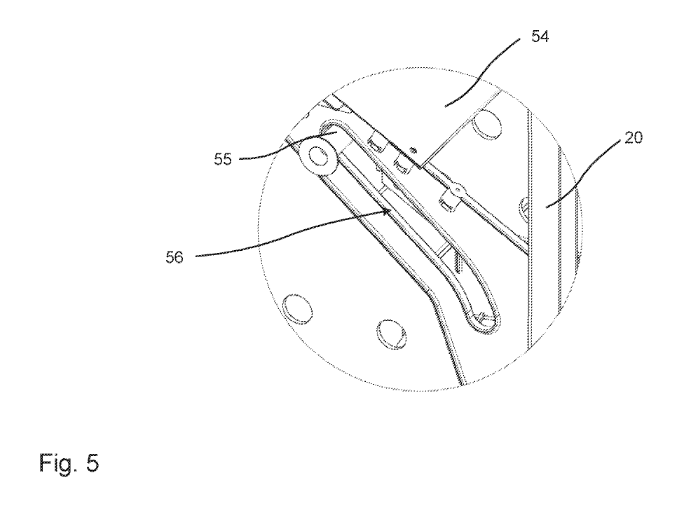

In another preferred variant, the nest roof extension element 58 has a depth in a direction from the roof ridge to the eaves, and said depth can be varied. It is particularly preferred that the plurality of different nest roof extension elements 58 are provided that have different depths and are replaceable. FIGS. 5 and 6 show how a nest access barrier can be realised. A guide recess 56 is provided for this purpose at a side wall at the first end 2 of poultry housing unit 1 and preferably likewise at a side wall at the second end 4 of poultry housing unit 1 and in partition walls 38. A guide pin 55 in the form of a long pipe is disposed on the nest access barrier and can be guided inside guide recess 56. This allows the nest access barrier to be moved back and forth. It can also be seen from FIG. 1 that the nest access barrier can be moved by means of a barrier pull element 310, in that the latter extends through the fixed covering element 54 to the nest access barrier. On the right-hand side of FIG. 2, it can be seen that guide pin 55 is arranged in an upper position. In this position, the nest access barrier is in an upper position, thus allowing access to the nest. On the left-hand side of FIG. 2, it can be seen that the guide pin is arranged in a lower position. In this position, the nest access barrier is in a lower position, so access to the nest is substantially impossible. To allow adjustment of the nest access barriers, barrier pull element 310 comprises a first lifting element 312 and a second lifting element 314.

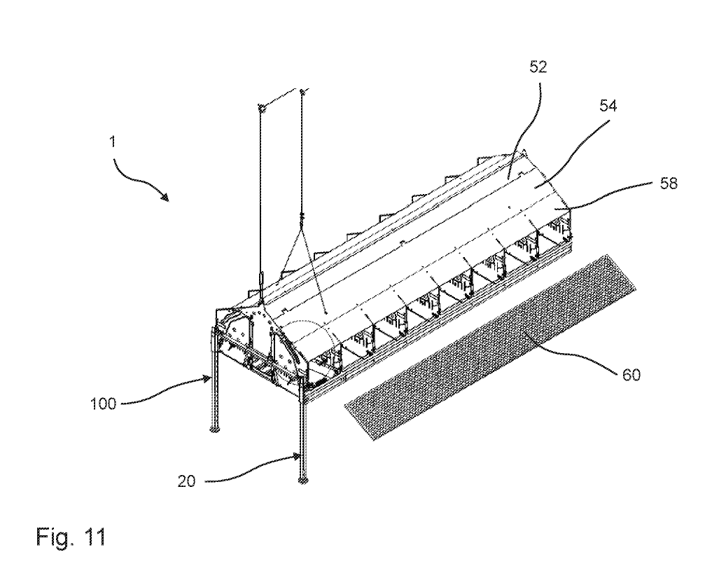

The poultry housing unit is also arranged at a nest lifting device 300, which can lift poultry housing unit 1. In FIG. 11, the poultry housing unit is shown in a state in which supporting elements 100, 20 are extended.

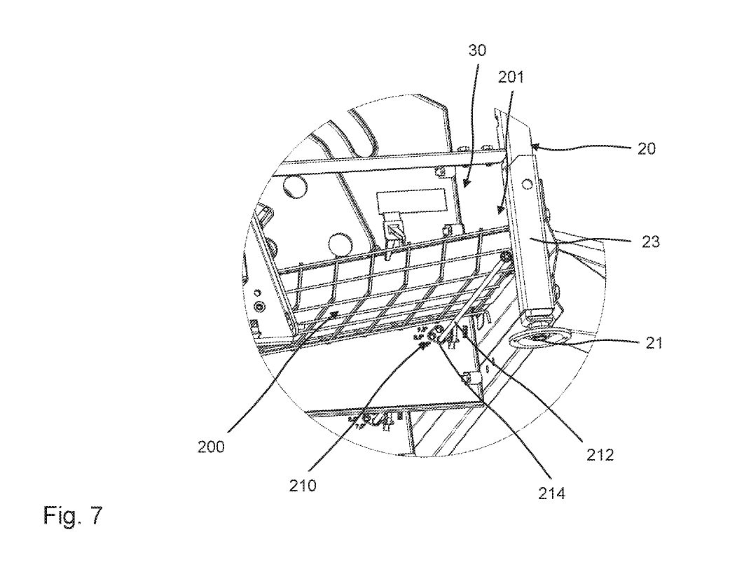

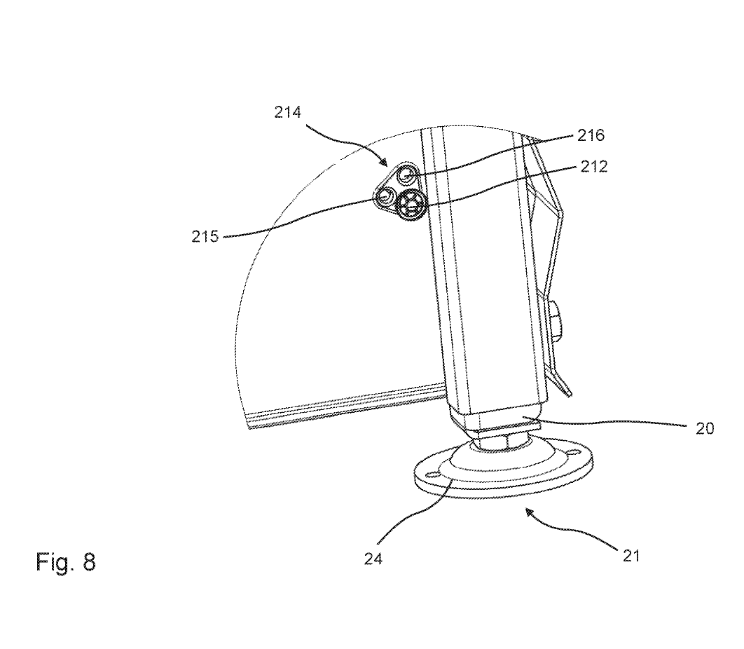

Details of how the nest boxes are arranged are shown in FIGS. 7 and 8. Nest box 30 has a tiltable walking area 200. The tiltable walking area 200 extends from an outer end located at an outer edge of poultry housing unit 1 to an inner end, which is not shown here, and which extends to an egg conveyor 40. The tiltable walking area 200 preferably has a gradient from its outer end 201 to the inner end. The gradient slopes downwards from the outer end 201 to the inner end. Due to this downwardly sloping gradient, an egg that is laid on the tiltable walking area 200 inside nest box 30 will roll towards the middle of the poultry housing unit, where egg conveyor 40 is arranged, as shown in FIG. 1.

The angle of inclination of the tiltable walking area 200 can be varied by means of a gradient adjustment device 210. Gradient adjustment device 210 comprises an adjusting rod 212, on which a section of the tiltable walking area 200 adjacent to the outer end 201 lies. Adjustment bar 212 can be adjusted in height by means of a locking device 214. As can be seen in FIG. 8, in particular, locking device 214 comprises a first locking hole 215, a second locking hole 216, and a third locking hole in which adjusting rod 212 is arranged. By arranging adjusting rod 212 in a higher locking hole, for example the second locking hole 216 or the first locking hole 215, the gradient of the tiltable walking area is increased.

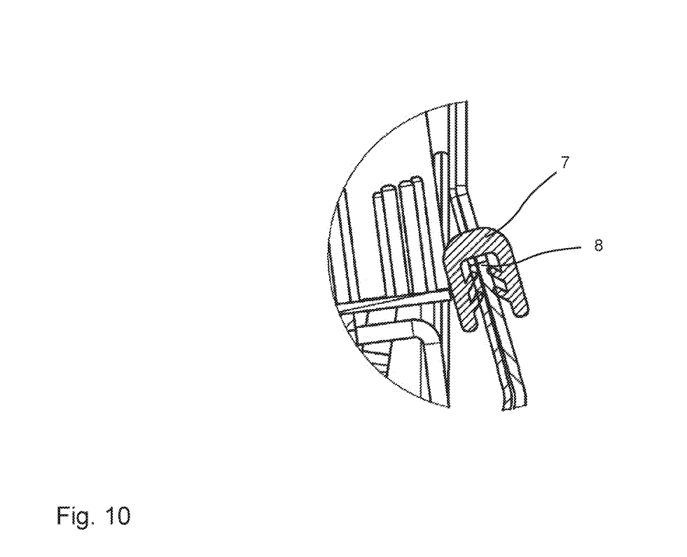

FIG. 10 shows an edge protection element 7. This is specifically provided for placement at an edge, in order to protect the animals. If the bridging element is not to be put in place, for example because of the height of poultry housing unit 1 or because of larger animals, edge protector 7 is intended to protect the edge in such a way that animals cannot injure themselves on it.

FIG. 12 shows the blocking mechanism with a spring-mounted catch 220, by means of which an override is realised. Catch 220 is mounted rotatably about a pivot point 222. The catch 220 has a latching end 221 that can be arranged in recesses (not shown) in the supporting element. Latching end 221 is spaced apart from pivot point 222, so a force that is not directed at pivot point 222 results at latching end 221 in a torque about pivot point 222. A spring element 224 is also provided that spaces catch 220 apart from pivot point 222, and which exerts a force in the direction of the recesses on latching end 221. A puller 225 is also provided at an unlatching end 223 and is arranged and adapted to move catch 220 in such a way that latching end 221, in particular, moves against the force of the spring, thus causing catch 220 to unlatch from the recess and the supporting element to be movable in a direction that provides support. Latching end 223 is likewise spaced apart from pivot point 222, so a force acting on latching end 223 causes a torque about pivot point 222.

Due to the first supporting element 100 and the second supporting element 20, poultry housing unit 1 can be adjusted in height with little effort. Adjusting the height of the poultry housing unit 1 above a supporting area can also be performed automatically and/or by a central control centre. As a consequence, the animals are disturbed less, find constant conditions where they enter their nests, despite an increasing amount of litter, and are thus kept in a more species-appropriate manner by the poultry housing unit, with the result that the well-being of the animals can be significantly increased.

Besides the vertical adjustment of the poultry housing unit, the well-being of the animals can also be increased by the removable covering element. By adjusting the height of the poultry housing unit, the lighting conditions in the nest boxes are changed accordingly, because the angle of incident light changes as a result of the vertical adjustment. In order to provide constant nesting conditions in this respect, it is possible, by means of the removable covering element 52 and the adjustable nest roof extension element 58, to provide identical or similar conditions. The gradient at which eggs roll away inside the nest boxes can also be varied. Thus, in addition to improved productivity, constant nest conditions also mean that the transportation of eggs can be improved.

It will be understood by one having ordinary skill in the art that construction of the described present disclosure and other components is not limited to any specific material. Other exemplary embodiments of the disclosure disclosed herein may be formed from a wide variety of materials, unless described otherwise herein.

For purposes of this disclosure, the term “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that many modifications are possible, e.g., variations in sizes, dimensions, structures, shapes and proportions of the various elements, values of parameters, mounting arrangements, use of materials, colors, orientations, etc. without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure and method without departing from the concepts of the present disclosure, and further it is to be understood that such concepts are intended to be covered by the following claims unless these claims by their language expressly state otherwise.

1.-18. (canceled)

19. A poultry housing unit, in particular for ducks to lay eggs, comprising:
a plurality of nest boxes arranged one beside the other above a floor area;
at least one supporting element extending in the vertical direction from a lower supporting end to an upper free end and arranged relatively movably in the vertical direction in relation to the floor area; and
a locking element operably coupled with the supporting element to block movement of the supporting element in a vertically upward supporting direction relative to the floor area and to allow movement of the supporting element relative to the floor area in a vertically downward direction of free motion.

20. The poultry housing unit pursuant to claim 19, wherein the floor area is formed by any of a grid arrangement, a rib arrangement, or a frame arrangement and has a triangular, rectangular or polygonal geometry; and
wherein a first supporting element is arranged in an area adjacent to a first corner.

21. The poultry housing unit pursuant to claim 20, further comprising a second supporting element arranged in an area adjacent to a second corner, a third supporting element is preferably arranged in an area adjacent to a third corner, and a fourth supporting element is preferably arranged in an area adjacent to a fourth corner.

22. The poultry housing unit pursuant to claim 19, wherein the at least one supporting element is held by means of a blocking mechanism against movement along its direction of extension, wherein the blocking mechanism preferably comprises any of:
at least one spring-mounted catch;
at least one movable latching element;
at least one frictional resistance;
at least one hydraulic unit; or
a brake mechanism.

23. The poultry housing unit pursuant to claim 19, wherein the at least one supporting element has recesses on least one outer side,
the at least one spring-mounted catch has a latching end at a distance from a pivot point, wherein said latching end can be arranged in the recesses, and a force in the direction of said recesses is preferably exerted upon it by a spring, and
the recesses and the catch are arranged and adapted such that the at least one supporting element is substantially unable to move in the supporting direction, wherein the latching end latches into a recess when the at least one supporting element moves in the supporting direction, and the at least one supporting element can be moved in the direction of free motion, wherein the latching end does not latch into a recess when the at least one supporting element moves in the direction of free motion.

24. The poultry housing unit pursuant to claim 22, wherein the spring has a spring force and the supporting element, when there is no load on it from the poultry housing unit, and by its own weight in the direction of free motion, can move the catch out of a latched position and can extend in the direction of free motion.

25. The poultry housing unit pursuant to claim 19, further comprising a release member arranged and adapted to allow movement of the at least one supporting element in the supporting direction.

26. The poultry housing unit pursuant to claim 25, wherein the release member engages a spring-mounted catch and is arranged and adapted to space a latching end of the spring-mounted catch from the supporting element.

27. The poultry housing unit pursuant to claim 22, wherein:
the blocking mechanism includes at least one spring-mounted catch, and
the release member is arranged and adapted to cause the spring-mounted catch to unlatch from a recess in the supporting element, wherein said unlatching can be triggered preferably centrally.

28. The poultry housing unit pursuant to claim 19, comprising:
a guide mechanism having a tubular geometry with an inner cross section,
the at least one supporting element having an outer cross section, wherein the inner cross section of the guide mechanism and the outer cross section of the supporting element have complimentary geometry, and
the inner cross section of the guide mechanism and the outer cross section of the supporting element are operably coupled whereby the at least one supporting element is movably arranged inside the guide mechanism.

29. The poultry housing unit according to claim 19, the poultry housing having a standing mode and an adjustment mode:
wherein in the standing mode the lower supporting end of the at least one supporting element is placed on a supporting area, the weight of the poultry housing unit is at least partially on the at least one supporting element, and the at least one supporting element supports the poultry housing unit at a defined distance above the supporting area, and wherein in the adjustment mode the weight of the poultry housing unit is substantially not on the at least one supporting element, and the at least one supporting element is arranged substantially movably by its own weight in the direction of free motion.

30. The poultry housing unit pursuant to claim 19, comprising a bridging element arranged and adapted to allow poultry access to the floor area, wherein the bridging element has a flat or stepped surface.

31. The poultry housing unit pursuant to claim 30, wherein the bridging element extends slopingly downwards from one edge of the poultry housing unit.

32. The poultry housing unit pursuant to claim 19, comprising a covering element, wherein in an operating mode, at least sections of said covering element are arranged over the floor area in the vertical direction.

33. The poultry housing unit pursuant to claim 19, wherein an egg collecting unit is arranged on one side of the at least one of the plurality of nest boxes; and
wherein laying sections of the plurality of nest boxes are spaced apart in the vertical direction from the egg collecting unit, whereby an adjustable gradient is provided from the laying section to the egg collecting unit.

34. The poultry housing unit pursuant to claim 19, wherein the nest boxes are each provided as an element which can be tilted about at least one horizontal axis.

35. The poultry housing unit pursuant to claim 19, comprising a nest access barrier arranged and adapted to block access for the poultry to at least one of the plurality of nest boxes.

36. The poultry housing unit pursuant to claim 19, comprising a side rail extending along one side in the region of the floor area and having one or more recesses in the region of the nest boxes.

37. A poultry house, in particular for the production of duck eggs, comprising a poultry housing unit pursuant to claim 19, wherein
the poultry housing unit further comprises a nest lifting device arranged and adapted to move the poultry housing unit relative to a supporting area to selectively increase a vertical distance between the poultry housing unit and the supporting area.

38. A method for keeping ducks, comprising the steps of:
providing a poultry housing unit comprising a plurality of nest boxes arranged one beside the other above a floor area; at least one supporting element extending in the vertical direction from a lower supporting end to an upper free end and arranged relatively movably in the vertical direction in relation to the floor area; and a locking element operably coupled with the supporting element to block movement of the supporting element in a vertically upward supporting direction relative to the floor area and to allow movement of the supporting element relative to the floor area in a vertically downward direction of free motion; and
moving the poultry housing unit in an adjustment mode in a substantially vertical direction, wherein a distance between a supporting area and the floor area is increased;
wherein the at least one supporting element extends by its own weight in the adjustment mode and supports the poultry housing unit in a subsequent standing mode with a defined distance between the supporting area and the floor area.
